(19) United States
(12) Patent Application Publication
(10) Pub. No.: US 2022/0168701 A1
(43) Pub. Date: Jun. 2, 2022

(54) PROCESS AND APPARATUS FOR QUANTITATIVE MONITORING OF THE COMPOSITION OF AN OLIGOMER/MONOMER MIXTURE

(71) Applicant: Covestro Intellectual Property GmbH & Co. KG, Leverkusen (DE)

(72) Inventors: Sebastian Koester, Köln (DE); Andreas Lyding, Duisburg (DE); Andreas Rose, Langenfeld (DE); Achim Symannek, Leichlingen (DE)

(21) Appl. No.: 17/437,190

(22) PCT Filed: Mar. 23, 2020
(86) PCT No.: PCT/EP2020/058008

§ 371 Date: Sep. 8, 2021

(30) Foreign Application Priority Data
Mar. 21, 2019 (EP) 19164232.1

(51) Int. Cl. B01J 19/00; B01J 4/02; G01N 21/359

(52) U.S. Cl. CPC B01J 19/0033; B01J 4/02; G01N 2021/3595; B01J 2219/00186; G01N 21/359

(57) ABSTRACT

The present invention relates to a process for quantitative monitoring of the composition of an oligomer/monomer mixture containing a plurality of mixture components. The process according to the invention is characterized in that the quantitative composition of the oligomer/monomer mixture is measured by means of an NIR spectroscopy measuring unit (7) under the application of a chemometric method, wherein the liquid pressure in the quantitatively monitored oligomer/monomer mixture p_{L}>3 bar. Further, the invention relates to an apparatus for quantitative monitoring of the composition of an oligomer/monomer mixture containing a plurality of mixture components, and an installation (100) for producing a polymer product.

### CROSS REFERENCE TO RELATED APPLICATIONS

This application is a U.S. national stage application, filed under 35 U.S.C. § 371, of International Application No. PCT/EP2020/058008, which was filed on Mar. 23, 2020, and which claims priority to European Patent Application No. 19164232.1, which was filed on Mar. 21, 2019. The contents of each are hereby incorporated by reference into this specification.

### FIELD

The invention relates to a method for quantitative monitoring of the composition of an oligomer/monomer mixture containing a plurality of mixture components, in particular a polyol mixture or an isocyanate mixture. The invention further relates to an apparatus for quantitative monitoring of the composition of an oligomer/monomer mixture and to a plant for production of a polymer product.

### BACKGROUND

In the production of a very wide variety of products in industrial chemistry, in particular in the production of polymeric materials, the maintaining of a defined stoichiometry of the reactants is of decisive importance for ensuring consistent product quality and yield. For example, in the production of polyurethane materials a defined stoichiometry of the participating polyols, isocyanates, activators, stabilizers, blowing agents etc. is to be maintained in an exactly specified amount to ensure sufficiently good and especially reproducible product quality. Nevertheless, in operational practice, continuous quality control during processing is often omitted.

The processor generally relies on the product specifications of the producer of the raw materials and on the metering precision of its own plants. Deviations from the target value due to incorrect mixing, storage or metering of individual components often go undetected and in the negative case lead to scrap material or variations in product quality.

There is therefore a need for a method for monitoring of the composition of an oligomer/monomer mixture containing a plurality of mixture components which allows precise quantitative analysis of the composition and further exhibits universal employability for quality control in production.

### SUMMARY

The object is achieved with a method for quantitative monitoring of the composition of an oligomer/monomer mixture containing a plurality of mixture components, in particular a polyol mixture or an isocyanate mixture, when the quantitative composition of the polymer mixture is measured by means of an NIR spectroscopy measurement unit using a chemometric method, wherein the liquid pressure in the quantitatively monitored oligomer/monomer mixture is p_{L}>3 bar.

An oligomer/monomer mixture in the context of the present invention may contain very predominantly oligomers (as well as residual monomers), a mixture of oligomers and monomers in differing ratio or very predominantly monomers (as well as residual oligomers), in each case in addition to additives. It is thus not pure oligomer/monomer mixtures that are at issue. In any case the components of the oligomer/monomer mixture are selected to take part in a polymerization reaction, in particular a polyaddition or polycondensation reaction. For example an oligomer/monomer mixture in the context of the invention may be an oligomer mixture formed by a polyol with additives which reacts with an isocyanate or an isocyanate mixture in a polyaddition reaction to afford a polyurethane material. The oligomer/monomer mixture in the context of the invention may likewise be an oligomer mixture formed by an oligomeric isocyanate, for example oligomeric MDI, as well as additives which reacts with a polyol or a polyol mixture to afford a polyurethane material. An oligomer/monomer mixture in the context of the invention may also be a monomer mixture formed by a monomeric isocyanate, such as TDI or monomeric MDI, as well as additives. Mixtures of monomeric and oligomeric MDI are likewise possible.

The particular advantage of using NIR spectroscopy for quantitative monitoring of the composition of an oligomer/monomer mixture is that the measurement may be performed with high precision while a production plant is in operation. In particular the measurement may be performed at pressures>3 bar so that it is also suitable inter alia for the quantitative monitoring of oligomer/monomer mixtures in pressurized vessels or conduits. These pressures inter alia minimize the occurrence of increased signal noise-inducing gas bubbles in the oligomer/monomer mixture to be examined. This is advantageous especially when for example gas is introduced into the oligomer/monomer mixture via the stirring means or the oligomer/monomer mixtures are processed using so-called gas loading as is sometimes the case in the production of polyurethane materials.

Near-infrared (NIR) spectroscopy is a technique widely used as an analytical method both in the laboratory and in online operations. Areas of application are, for example, the continuous analysis of wine (W02007/006099A1), bitumen (U.S. Pat. No. 7,067,811B2) or insulin (U.S. Pat. No. 7,755,051B2). NIR spectroscopy is also used to determine particle sizes (US2015/0293005) or OH numbers (EP 3 179 232 A1). The use of NIR techniques for specific measurement tasks is also known from: WO 00/02035 (determination of organic acid in organic polymer), U.S. Ser. No. 00/571,7209 (spectral analysis of hydrocarbons), U.S. Ser. No. 00/622,8650; WO 99/31485 (control of the separation of chemical components in an alkylation process with an acid catalyst), U.S. Pat. No. 6,339,222; WO 00/68664 (determination of ionic species in pulp liquor), DE 10005130A1 (control of polymer processes, determination of NCO in PU)

The combination of NIR spectroscopy with chemometric evaluation methods for specific measurement tasks is likewise known per se from the prior art, for example DE 21 39 269, WO 97/41420, WO 98/29787, WO 99/31485, JP 11350368, JP 2000146835, JP 2000298512, WO 2002/04394, WO 2002/12969, U.S. Pat. Nos. 5,707,870, 5,712,481, and WO 2000/68664.

Chemometric evaluation methods are based, for example, on the partial least square method (PLS), such as for example in Raphael Vieira “In-line and In Situ Monitoring of Semi-Batch Emulsion Copolymerizations Using Near-Infrared Spectroscopy” J Applied Polymer Science, Vol. 84, 2 670-2 682 (2002). Further information about chemometric evaluation methods may be found in T. Rohe “Near Infrared (NIR) spectroscopy for inline monitoring of polymer extrusion processes” Talanta 50 (1999) 283-290 and C. Miller “Chemometrics for on-line spectroscopy applications—theory and practice”, J Chemometrics 2000; 14: 513-528 and “Multivariate Analysis of Near-Infrared Spectra Using G-Programming Language” J. Chem. Inf. Comput. Sci. 2000, 40, 1 093-1 100.

An overview of the use of multivariate chemometric calibration models in analytical chemistry is also provided by “Multivariate Calibration”, Jörg-Peter Conzen, 2001, ISBN 3-929431-13-0.

### BRIEF DESCRIPTION OF DRAWINGS

The present invention is hereinbelow elucidated with reference to a drawing representing an exemplary embodiment of the invention. In the figures:

FIG. 1 shows a plant for production of a polyurethane material in a heavily schematized representation and

FIG. 2 shows parts of an apparatus for quantitative monitoring of the composition of a polyol mixture in a highly schematized view.

### DETAILED DESCRIPTION

As mentioned, it is provided according to the invention that the liquid pressure in the quantitatively monitored oligomer/monomer mixture is p_{L}>3 bar. In a first further embodiment of the invention it is provided that the liquid pressure in the quantitatively monitored oligomer/monomer mixture is p_{L}>20 bar and particularly preferably >120 bar. Such high pressures are employed for example in polyurethane production where a mixing of the reactants by countercurrent injection is effected.

In a further advantageous embodiment of the invention the NIR spectroscopy is performed in a wavelength range of 700-3000 nm, preferably 780-2500 nm and particularly preferably 1000 nm-2250 nm.

In an advantageous embodiment of the invention the NIR spectroscopy may be performed as a transmission measurement, in particular as an online transmission measurement, wherein the beam source and the detector element are arranged opposite one another. In this case the distance between the beam source and the detector element may be 1 to 20 mm. This ensures on the one hand that a sufficient amount of the oligomer/monomer mixture is transirradiated to obtain a sufficient signal-to-noise ratio. On the other hand, excessive attenuation of the intensity of the NIR radiation is avoided. “Online transmission measurement” in the context of the present invention is understood as meaning that the measurement may be performed online, i.e. without sample withdrawal but rather in a running process for example, in particular a production process. An NIR measurement cell may preferably be integrated into a conduit with which the oligomer/monomer mixture is supplied to a reactor. A measurement probe may alternatively be integrated into the receiver vessel of the plant.

Alternatively to the transmission measurement the measurement by NIR spectroscopy may also be carried out as a transflection measurement, wherein by reflection of the measurement beam at a reflecting surface the oligomer/monomer mixture is effectively transirradiated twice.

Different measurement setups may be employed for the NIR spectroscopy measurement unit. It is thus provided in a further advantageous embodiment of the invention that the NIR spectroscopy measurement unit is a diode array spectrometer or an FTIR spectrometer.

The NIR spectroscopy measurement unit is particularly preferably an FT spectrometer, wherein the quantitative composition of the oligomer/monomer mixture is measured quasi-continuously. Quasi-continuous measurement makes it possible to achieve a particularly close monitoring of the composition of the oligomer/monomer mixture, thus providing virtually real-time information on the quantitative composition of the monitored oligomer/monomer mixture.

The method according to the invention may be used in different positions, for example in a production line or else in a laboratory environment. It is thus provided in a further advantageous embodiment of the invention that the oligomer/monomer mixture is stored in a pressurized vessel or conducted in a pressurized conduit, preferably in a circulation conduit, wherein the individual mixture components of the oligomer/monomer mixture are each supplied to the vessel or the conduit via feed conduits.

The measured values from the quantitative monitoring of the composition of the oligomer/monomer mixture are particularly suitable for closed-loop control of the composition. Thus in a further embodiment of the invention the measured values from the NIR spectroscopy measurement unit may be transmitted to a control unit, wherein upon deviation from a target composition of the oligomer/monomer mixture the control unit sends a control signal to a metering unit arranged in at least one feed conduit.

A particularly advantageous application of the method according to the invention is the quantitative monitoring of the composition of a plurality of oligomer/monomer mixtures that are mixed with one another and thus react with one another for production of a particular polymer product for example. In particular a first oligomer/monomer mixture and at least one second oligomer/monomer mixture may be provided, wherein the first oligomer/monomer mixture is introduced into a mixing and reaction unit via a first conduit and the at least one second oligomer/monomer mixture is introduced into the mixing and reaction unit via at least one second conduit, wherein the first oligomer/monomer mixture and the at least one second oligomer/monomer mixture are mixed therein and react with one another to afford a polymer product, wherein the composition of the first oligomer/monomer mixture and/or the quantitative composition of the second oligomer/monomer mixture is/are quantitatively monitored using the NIR spectroscopy measurement unit.

It has proven particularly suitable when the NIR spectroscopy for monitoring the quantitative composition of the first oligomer/monomer mixture in the first conduit and/or the quantitative composition of the oligomer/monomer mixture in the at least one second conduit is performed in the region of the connection of the first conduit and/or the at least one second conduit to the mixing and reaction unit.

A further aspect of the present invention relates to a method for production of a polymer product, in particular a polyurethane product, from a first oligomer/monomer mixture and at least one second oligomer/monomer mixture as claimed in any of claim 10 or 11. The abovementioned advantages apply correspondingly to the advantages of this method.

A further aspect of the present invention relates to an apparatus for quantitative monitoring of the composition of an oligomer/monomer mixture containing a plurality of mixture components, wherein the apparatus comprises at least one container or at least one conduit for storage or conduction of the oligomer/monomer mixture at a liquid pressure of p_{L}>3 bar, wherein the apparatus further comprises an NIR spectroscopy measurement unit, wherein the apparatus is adapted for quantitative monitoring of the composition of the oligomer/monomer mixture by the method as claimed in any of claims 1 to 12.

The abovementioned advantages again apply correspondingly to the advantages of this method.

In an advantageous embodiment of the invention the apparatus provides a control unit, wherein the control unit is configured such that in the case of a quantitative deviation in the composition of the oligomer/monomer mixture stored or conducted in the container or the at least one conduit from a target composition it sends a control signal to a metering unit arranged in at least one feed conduit to the container or to the conduit.

A further aspect of the present invention relates to a plant for production of a polymer product, in particular a polyurethane material, comprising:
a mixing and reaction unit for mixing a first oligomer/monomer mixture and at least one second oligomer/monomer mixture,
a first conduit in fluid communication with the mixing and reaction unit and at least one second conduit in fluid communication with the mixing and reaction unit,
   wherein the first conduit is configured to introduce the first oligomer/monomer mixture into the mixing and reaction unit at a liquid pressure p_{L}>3 bar and/or the at least one second conduit is configured to introduce the at least one second oligomer/monomer mixture into the mixing and reaction unit at a liquid pressure p_{L}>3 bar, wherein at least one NIR spectroscopy measurement unit is provided, wherein the at least one NIR spectroscopy measurement unit is configured to monitor the quantitative composition of the first oligomer/monomer mixture in the first conduit and/or the quantitative composition of the at least one second oligomer/monomer mixture in the at least one second conduit by the method as claimed in any of claims 1 to 12.

A further aspect relates to a method for determining the blowing agent concentration in an oligomer/monomer mixture. To this end it is proposed to record an NIR spectrum of a reference mixture, for example of a system comprising a polyol, activators, catalysts and optionally further components but without blowing agent. This NIR spectrum may be referred to as a background spectrum. A defined blowing agent content is then added to the reference mixture (for example 2% by weight) and another NIR spectrum recorded. The blowing agent content is successively increased (2%, 4%, 6%, . . . ) and further NIR spectra are recorded.

The background spectrum is subtracted from each individual spectrum of the mixture of defined, increasing blowing agent content in order to form in each case a differential spectrum or residuum showing the spectral effect of the blowing agent.

These differential spectra then allow development of a specialized chemometric method which may be used for determining unknown blowing agent contents. To this end a mixture of unknown composition initially has its NIR spectrum without blowing agent determined and stored in an evaluation computer for example. If this mixture is then present with unknown blowing agent content for example in a plant or a container an NIR spectrum of this mixture may likewise be recorded. The NIR spectrum characterizing the mixture of unknown blowing agent concentration in turn has the background spectrum of this mixture (i.e. without blowing agent) subtracted from it, for example using the evaluation computer, and the specialized chemometric method may be applied to the differential spectrum for precise determination of the blowing agent content in the mixture of unknown composition.

Contemplated blowing agents include for example cyclopentane or mixtures of cyclopentane and isopentane, as well as n-pentane or the class of hydrofluoroolefins.

The method described hereinabove thus makes it possible to precisely determine the blowing agent concentration in a mixture of unknown composition using a simple specialized chemometric method.

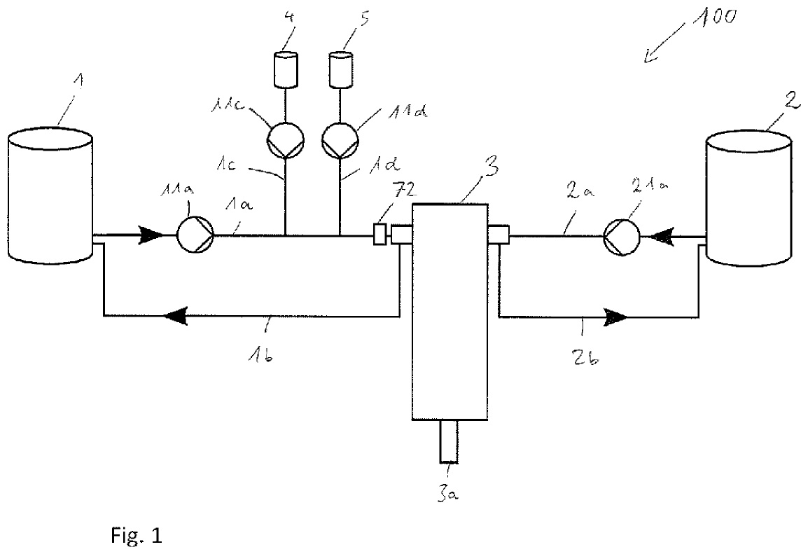

FIG. 1 shows a plant 1 for production of a rigid polyurethane foam in a highly schematized representation. The plant 100 comprises two containers 1, 2, in which a polyol (container 1) as well as additives, such as activator, catalyst or other materials, and an isocyanate (container 2) as well as additives are stored as raw materials of the polyurethane material. Container 1 is connected to a mixing and reaction unit 3 via a first conduit 1a. Container 2 is likewise connected to the mixing and reaction unit 3 via a second conduit 2a. The two reactant streams react in the mixing and reaction unit 3 and the reaction mixture is passed via an outlet pipe 3a into a mold (not shown) where it forms the desired rigid polyurethane foam.

The first conduit 1a and the second conduit 2a each have a pump unit 11a, 21a for conveying the respective materials streams arranged in them. The first and the second conduit 1a, 2a are moreover each configured as a circulation conduit each having a return leg 1b, 2b from the mixing and reaction unit 3 to the containers 1, 2. A pressure of p_{L}>3 bar, presently 130 bar (countercurrent injection), prevails in both conduits 1a, 1b.

As is also apparent in FIG. 1 two further conduits 1c, 1d open into the first conduit 1a connecting the container 1 with the mixing and reaction unit 3. Via these conduits 1c, 1d necessary additives/blowing agents for producing the rigid polyurethane foam are added to the polyol transported in conduit 1a from containers 4, 5. These may be blowing agents or catalysts for example. The conduits 1c, 1d fed from the containers 4, 5 which each likewise comprise pump units 11c, 11d are shown here by way of example. It will be appreciated that depending on the application a markedly larger number of additives may also be added to the polyol and/or the isocyanate.

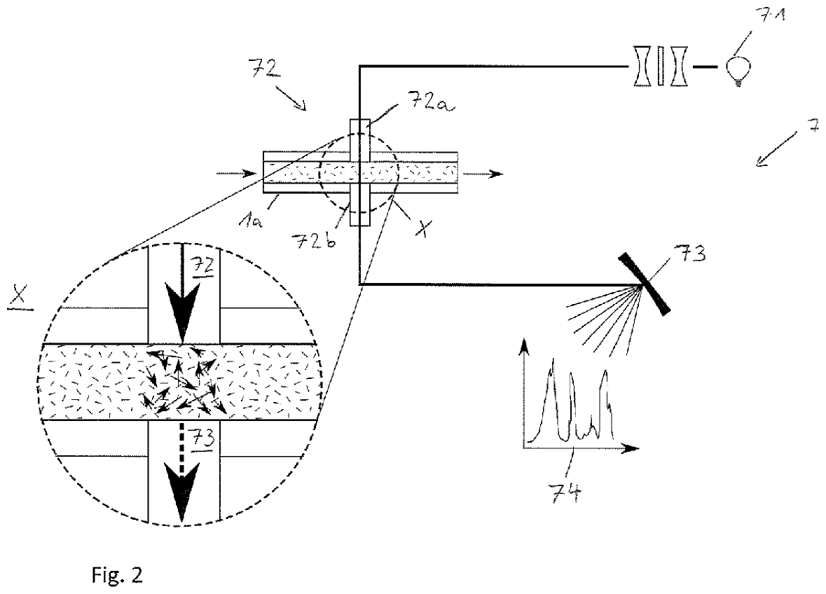

The test cell 72 of an NIR spectroscopy measurement unit 7 (see FIG. 2) is integrated into the conduit 1a in the immediate vicinity of the mixing and reaction unit 3 on the side of the polyol feed, i.e. on the pressure side of the pump unit 11a. Further variants in which the NIR spectroscopy measurement unit is provided only on the isocyanate side (conduit 2a) or on both sides of the mixing and reaction unit are not shown. As is also elucidated in detail in connection with FIG. 2 the NIR spectroscopy measurement unit 7 can be used to quantitatively monitor the composition of the polyol mixture in the immediate vicinity of the entrance to the mixing and reaction unit 3 and the output signal from the NIR spectroscopy measurement unit 7 used for keeping the composition of the polyol mixture constant via a control unit (not shown). In an alternative/batchwise operating mode the material from containers 1, 2 may be recirculated through the conduits 1a, 1b, 2a, 2b and provided with additives such as for example via conduit 1c, 1d until the desired composition in containers 1, 2 has been established.

FIG. 2 shows parts of an apparatus for quantitative monitoring of the composition of a polyol mixture in a highly schematized view. Specifically, FIG. 2 shows the test cell 72 of an NIR spectroscopy measurement unit 7 with enlarged detail X. The test cell 72 comprises the section of the conduit 1a from FIG. 1 and, connected thereto, two sensors 72a, 72b arranged opposite one another. Sensor 72a functions as a radiation source, by means of which an NIR measurement signal is radiated into the polyol mixture flowing through the conduit 1a. The NIR measurement signal is generated by a corresponding NIR radiation source and passed via optics into an optical fiber cable through which it reaches the measurement sensor 72a.

The NIR measurement signal radiated into the conduit 1a, through which the polyol mixture flows, undergoes a wavelength-dependent attenuation through absorption and in some cases also scattering (cf. detail X). The attenuated signal is then detected by the NIR-sensitive measurement sensor 72b as the detector element and for example passed via a further optical fiber cable to a spectrometer construction 73, for example in the form of an interferometer. The distance between the sensor 72a (beam source) and the sensor 72b (detector element) can be established within a wide range, for example between 1 and 20 mm, depending on the absorption and scattering behavior of the mixture flowing through the conduit 1a.

The spectrum 74 obtained in the spectrometer construction 73 may then be passed to an electronic evaluation and display unit (not shown). The measurement signal recorded using the NIR spectroscopy measurement unit 7 is particularly suitable for a control loop in which the quantitative composition of the polyol mixture in the conduit 1a, 1b is monitored. If for example the NIR spectroscopy measurement unit 7 determines an insufficient proportion of a mixture component, for example of the additive from the container 4, a control signal is sent to the corresponding pump unit 11c which induces an elevated metering of this additive until the NIR spectroscopy measurement unit 7 once again measures the correct proportion of the additive in the polyol mixture.

The particular advantage of the method of measurement is also that the measurements may be carried out quasi-continuously, thus allowing corresponding deviations from the target composition to be very quickly compensated by the control system.

1. A method for quantitative monitoring of a composition of an oligomer/monomer mixture containing a plurality of mixture components, wherein a quantitative composition of the oligomer/monomer mixture is measured by means of a Near-infrared (NIR) spectroscopy measurement unit using a chemometric method, wherein a liquid pressure in the quantitatively monitored oligomer/monomer mixture is p_{L}>3 bar.

2. The method as claimed in claim 1, wherein the liquid pressure in the quantitatively monitored oligomer/monomer mixture is p_{L}>20 bar.

3. The method as claimed in claim 1, wherein the measurement by means of the NIR spectroscopy measurement unit is performed in a wavelength range of 700-3000 nm.

4. The method as claimed in claim 1, wherein the measurement by means of the NIR spectroscopy measurement unit is performed as a transmission measurement, wherein a beam source and a detector element are arranged opposite one another.

5. The method as claimed in claim 4, wherein the distance between the beam source and the detector element is 1 to 20 mm.

6. The method as claimed in claim 1, wherein the NIR spectroscopy measurement unit is a diode array spectrometer or an FTIR spectrometer.

7. The method as claimed in claim 6, wherein the NIR spectroscopy measurement unit is an FT spectrometer and the quantitative composition of the oligomer/monomer mixture is measured quasi-continuously.

8. The method as claimed in claim 1, wherein the oligomer/monomer mixture is stored in a pressurized vessel or conducted in a pressurized conduit, wherein the individual mixture components of the oligomer/monomer mixture are each supplied to the vessel or the conduit via feed conduits.

9. The method as claimed in claim 8, wherein the measured values from the NIR spectroscopy measurement unit are transmitted to a control unit, wherein upon deviation from a target composition of the oligomer/monomer mixture the control unit sends a control signal to a metering unit arranged in at least one feed conduit.

10. The method as claimed in claim 8, wherein a first oligomer/monomer mixture and at least one second oligomer/monomer mixture are provided, wherein the first oligomer/monomer mixture is introduced into a mixing and reaction unit via a first conduit and the at least one second oligomer/monomer mixture is introduced into the mixing and reaction unit via at least one second conduit, wherein the first oligomer/monomer mixture and the at least one second oligomer/monomer mixture are mixed therein and react with one another to afford a polymer product, wherein the composition of the first oligomer/monomer mixture and/or the composition of the second oligomer/monomer mixture is/are quantitatively monitored using the NIR spectroscopy measurement unit.

11. The method as claimed in claim 10, wherein the NIR spectroscopy for monitoring the quantitative composition of the first oligomer/monomer mixture in the first conduit and/or the quantitative composition of the oligomer/monomer mixture in the at least one second conduit is performed in the region of the connection of the first conduit and/or the at least one second conduit to the mixing and reaction unit.

12. A method for production of a polymer product, from a first oligomer/monomer mixture and at least one second oligomer/monomer mixture as claimed in claim 10.

13. An apparatus for quantitative monitoring of a composition of an oligomer/monomer mixture containing a plurality of mixture components, wherein the apparatus comprises at least one container or at least one conduit for storage or conduction of the oligomer/monomer mixture at a liquid pressure of p_{L}>3 bar, wherein the apparatus further comprises an NIR spectroscopy measurement unit, wherein the apparatus is adapted for quantitative monitoring of the composition of the oligomer/monomer mixture by the method as claimed in claim 1.

14. The apparatus as claimed in claim 13, wherein a control unit is provided, wherein the control unit is configured such that in the case of a quantitative deviation in the composition of the oligomer/monomer mixture stored or conducted in the container or the at least one conduit from a target composition the control unit sends a control signal to a metering unit arranged in at least one feed conduit to the container or to the at least one conduit.

15. A plant for production of a polymer product, comprising:
a mixing and reaction unit for mixing a first oligomer/monomer mixture and at least one second oligomer/monomer mixture,
a first conduit in fluid communication with the mixing and reaction unit and at least one second conduit in fluid communication with the mixing and reaction unit, wherein the first conduit is configured to introduce the first oligomer/monomer mixture into the mixing and reaction unit at a liquid pressure p_{L}>3 bar and/or the at least one second conduit is configured to introduce the at least one second oligomer/monomer mixture into the mixing and reaction unit at a liquid pressure p_{L}>3 bar, wherein at least one NIR spectroscopy measurement unit is provided, wherein the at least one NIR spectroscopy measurement unit is configured to monitor a quantitative composition of the first oligomer/monomer mixture in the first conduit and/or a quantitative composition of the at least one second oligomer/monomer mixture in the at least one second conduit by the method as claimed in claim 1.

16. The method as claimed in claim 1, wherein the oligomer/monomer mixture is a polyol mixture or an isocyanate mixture.

17. The method as claimed in claim 2, wherein the liquid pressure in the quantitatively monitored oligomer/monomer mixture is p_{L}>120 bar.

18. The method as claimed in claim 3, wherein the measurement by means of the NIR spectroscopy measurement unit is performed in a wavelength range of 1000 nm-2250 nm.

19. The method as claimed in claim 4, wherein the measurement by means of the NIR spectroscopy measurement unit is performed as an online transmission measurement.

20. The method as claimed in claim 8, wherein the pressurized conduit is a circulation conduit.
